(19) United States
(12) Patent Application Publication
(10) Pub. No.: US 2009/0146580 A1
(43) Pub. Date: Jun. 11, 2009

(54) HIGH INTENSITY DISCHARGE LAMP DRIVER WITH VOLTAGE FEEDBACK CONTROLLER

(75) Inventors: Dolf Henricus Jozef Van Casteren, Eindhoven (NL); Felix Godfried Peter Peeters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,769

(22) PCT Filed: Nov. 18, 2005
(86) PCT No.: PCT/IB05/53812

§ 371 Date: May 21, 2007

(30) Foreign Application Priority Data
Nov. 24, 2004 (EP) 04106033.6

(51) Int. Cl. H05B 41/36

(52) U.S. Cl. 315/291

(57) ABSTRACT

Current arrangement for operating a high intensity discharge lamp or a ultra high pressure discharge lamp, comprising a DC-to-DC converter, a control circuit for controlling the output value of the DC-to-DC converter, and a commutator. The control circuit comprises two control loops, one of which controlling an absolute average value of the lamp current, the other of which controlling and minimizing small variations of the lamp current around a reference value. An adaptive control of the first and second loop controllers can be used to adjust the controllers to changing system dynamics.

The invention relates to a circuit arrangement that can be used as a ballast for Gas discharge lamps.

For operating gas discharge lamps, and in particular high intensity discharge (HID) lamps for ultra high pressure discharge (UHP) lamps, dedicated circuits known as lamp ballasts are employed in order to achieve the desired lighting characteristics and to avoid premature deterioration of the gas discharge lamp. It is known that submitting the lamp to a square wave current with relatively low frequency yields satisfactory results with respect to both, lighting characteristics and to durability of the lamp. The lamp ballast has the task of converting a sinusoidal current that is provided by a mains supply network to an appropriate square wave current to be applied to the gas discharge lamp. Accordingly, a lamp ballast circuit is a power electronics equipment that comprises at least a rectifier, a DC-to-DC converter, and a commutator. The rectifier is connected to the mains supply network and provides a substantially constant direct voltage. The DC-to-DC converter adapts the voltage produced by the rectifier to that needed by the gas discharge lamp. The commutator is typically a full bridge comprising four switching elements that inverses the direction of a DC current at each half period of the low frequency square wave cycle.

At the side of the lamp ballast that is connected to the mains supply network (mostly pre-conditioner), additional filter means are usually provided to avoid that the lamp ballast draws to much reactive power from the mains supply network and regenerates high frequency current components resulting from the switching actions into to mains supply network.

While for standard lighting applications lamp durability is the predominant factor, new fields of application for gas discharge lamps, such as in projection devices, such as beamers, projection television sets etc., require a highly constant light output in order to avoid flickering phenomena and long term deterioration of light output performance. The combination of gas discharge lamp and lamp ballast forms are dynamic system that is usually a resonance circuit. More over, it is weakly damped. Accordingly, a strong oscillatory behavior can be observed for the voltage across and the current through the lamp at each switching event of the commutator. This oscillating behavior again leads to flickering and additional audible driver noise, which is particularly undesired for projection applications.

Since the light output of the gas discharge lamp depends particularly on the current flowing through the lamp, maintaining the lamp current at a constant absolute value is an obvious solution. This can be achieved by e.g. a feedforward control or a feedback control loop for the lamp current. Yet, even a feedback control loop can handle changes of the reference signal or additive disturbances to plant output, which in the present case is the lamp current. However, such a control scheme is rather inappropriate for handling variations of the dynamic system itself. Therefore, such a control scheme cannot provide satisfactory performance, if the dynamic properties of the system comprising ballast and lamp vary significantly. Yet, especially gas discharge lamps are known to present strong varying dynamic characteristics throughout their lifetime. Also, when a cold lamp is switched on, the system dynamics of the lamp go through strong variations until it has reached its operating temperature, which may take from a few seconds to several minutes. More over it has not been considered up to now that the absolute value of the lamp current is set by means of the DC-to-DC converter, while its sign is controlled by the commutator. Unless a user adjusts the brightness level of the lamp manually, the absolute value of the lamp current remains constant during stationary operations. The sign of the lamp current on the other hand changes periodically with the square wave cycle. The dynamic system ballast-lamp reacts mostly to the abrupt changes when the commutator switches from one half cycle to the next half cycle of the square wave. Accordingly, two control tasks exist, that are quite different one from the other. While for adjusting the absolute value of the lamp current a slow response time suffices, suppressing the oscillations that occur after commutator switching events requires a fast responding control loop. On the other hand, tracking errors are undesired for the control task concerning the absolute value of the lamp current.

Current measurement is usually performed by means of a shunt. Since a shunt is usually voluminous and dissipative, an alternative circuit arrangement for measuring a current is needed.

To address the above-discussed deficiencies of the prior art, the present invention provides a circuit arrangement for operating a high intensity discharge (HID) lamp. The circuit arrangement comprises input terminals for connection to a supply voltage source, a DC-to-DC converter coupled to the input terminals for generating a DC current out of a supply voltage supplied by the supply voltage source, a control circuit for controlling the DC current at a value that is represented by a reference value Iref, and a commutator for commutating the DC current and comprising lamp connection terminals. The circuit arrangement is characterized in that the control circuit comprises a first control loop for controlling an average of said DC current to said reference value Iref, and a second control loop for controlling small variations of said DC current around said reference value Iref caused by said commutation of said DC current. Such a control scheme accounts for the fact that in the considered circuit arrangement two control tasks need to be performed. The first task consists in maintaining the absolute value of a current flowing out of the DC-to-DC converter as constant as possible. The second task consists in reducing oscillations of the lamp current caused by the commutator periodically inversing the direction of the lamp current, pulse operation and other disturbances.

In one embodiment of the present invention, the reference value Iref is determined depending on a desired output power value. Once the high intensity discharge lamp is ignited, the current flowing through the lamp determines the working point, and therefore the voltage across the lamp and the power consumed by the lamp. Accordingly, control of the lamp power consumption is achieved by controlling the lamp current. If the lamp characteristic and admissible ranges of operation are known, a reference value Iref for the lamp current can be determined according to a working point, at which the power consumption of the lamp (and its approximate light output) mach a desired value.

In the related embodiment, the reference value Iref is determined depending further on a voltage measured at the input of the commutator. Although the current-voltage characteristic of a high intensity discharge lamp is some what complicated, the current flowing through the lamp can be estimated, if a measurement for the voltage across the lamp is available and the current-voltage characteristic of the lamp is known. In this manner, additional effort for a current measurement can be avoided.

In one embodiment of the present invention, the first control loop comprises a measurement unit for the input voltage to the commutator, a voltage divider, and a DC blocking circuit. This allows the measurement of a small AC signal. The voltage divider is used for scaling the measured voltage, and the DC blocking circuit filters out DC component of the voltage. If the amplitude of the measured small AC signal is not too large, the dynamic system consisting of the discharge lamp and lamp ballast presenting the measured voltage may be linearized around the working point. For this reason, even a first control loop with only a simple controller is capable of achieving good control results.

In one embodiment of the present invention, the first control loop has a high bandwidth and is adapted to control a dynamic system comprising the high intensity discharge lamp and a lamp ballast. This dynamic system usually has very small time constant so that a control loop for the dynamic system must be capable of handling a high bandwidth. Since the high intensity discharge lamp is connected to the lamp ballast, their combined dynamic system must be considered rather than that of the high intensity discharge lamp alone.

The second control loop may comprise means adapted to determine the reference value Iref from a measured voltage signal and a desired output power value. The second control loop is charged with controlling the average absolute value of the lamp current. It also controls the power consumption of the high intensity discharge lamp. In order to account for a change in the lamp's and/or the lamp ballast's characteristics, the reference value for the lamp current Iref is determined as a function of a measured voltage. Knowing the instantaneous voltage and the desired output power value of the lamp, the reference value Iref can be determined.

In one embodiment of the present invention, the inverted output of the first control loop is added to the output of the second control loop and the result is applied to the DC-to-DC converter as control signal. In this manner, the superposition of the control signals determined by each of the first and the second control loops is calculated. The superposition control signal therefore comprises the high bandwidth small AC control signal issued by the second control loop and the more inert signal for the average absolute lamp current issued by the first control loop. Adding two signals is an easy to function in both, analogue and digital circuits.

In a related embodiment the means adapted to determine the reference value Iref is a look-up table adapted to interrelate the reference value Iref to a measured input voltage for the commutator and a desired output power. Such a look-up table may comprise two columns, one for the measured input voltage for the commutator, and one for the reference value Iref. Each pair of values belonging together, i.e. belonging to the same row in the look-up table, leads to the same power consumption of the lamp. It may also be considered to have a look-up table comprising several pages each corresponding to a different output power value. By switching from one page of the look-up table to another, a brightness adjustment of the lamp, within a reasonable range, can be achieved. By using a look up table, even complicated non-linear dependencies can be implemented.

In another related embodiment, the means adapted to determine the reference value Iref is a microprocessor configured to execute of program in real time. The use of a microprocessor allows for calculating the reference value Iref by a program that is performed periodically or when requested (e.g. by an interrupt).

In one embodiment of the present invention, the first control loop comprises an analogue controller and the second control loop comprises the digital microprocessor. The high bandwidth control task of the second control loop is performed by an analogue circuit that is well suited for this task, since it handles continuous signals. The digital microprocessor used in the second control loop forms a digital control of the average lamp current, which can be achieved by even a relatively slow processor. However, the use of a microprocessor for the first control loop greatly simplifies the implementation or a calculation function for the reference signal Iref.

In an alternative embodiment of the present invention, the first control loop and the second control loop comprise a digital signal processor (DSP) digitally performing a high bandwidth control task of the second control loop and a lower bandwidth control task of the first control loop. This implementation has the advantage that a device that is capable of performing fast calculations, such as a DSP can be used for both control loops. Having a single calculation device handling both control loops reduces the component count of the circuit arrangement, which ultimately leads to less required space and reduced complexity of the circuit layout.

In one embodiment of the present invention, the control circuit comprises an adaptive feedback control for adjusting at least one of the first and second control loops according to variations of the control system comprising the high intensity discharge lamp and a lamp ballast. During start up and with increasing lifetime, a high intensity discharge lamp shows variations with respect to its electrical and dynamic behavior. For this reason, a control loop that is tuned to a specific combination of a high intensity discharge lamp and a lamp ballast experiences performance deterioration with increasing lifetime of the high intensity discharge lamp. With an adaptive feedback control loop, the first and/or the second control loop are adjusted to the actual system behavior so that control criteria such as fast response time, small overshoot, and small or no tracking error are met by the control loops during the entire lifetime of the lamp.

According to a related embodiment, the first control loop is a current feedback loop and the second control loop is a voltage feedback loop to achieve damping. The main control task is the current control. However, for small AC variations in the vicinity of a working point, a voltage feedback loop can achieve similar results. Accordingly, an actual current feedback control loop is needed for the quasi DC-component of the current, only. The feedback in the current control loop provides the capability of reducing tracking errors and reacting to disturbances influencing the system output.

The first control loop may comprise a shunt before the commutator and a first feedback controller having at least one connection to the adaptive feedback controller. A shunt assures a measurement of the current flowing into the commutator. A connection between the first feedback controller for the first control loop and the adaptive feedback controller allows the first feedback controller to be tuned by the adaptive feedback controller. The adaptive feedback controller determines optimal values for the first feedback controller based on an analysis of the actual system behavior.

The second control loop may comprise means for sensing the output voltage of the DC-to-DC converter and a second feedback controller having at least one connection to the adaptive feedback controller. That means for something the output voltage of the DC-to-DC converter provide a feedback signal, since the output voltage of the converter equals the input voltage of the commutator and therefore, except for the voltage drops across the two conducting switching elements of the commutator, also equals the lamp voltage. By means of a connection between the second feedback controller and the adaptive feedback controller, the adaptive feedback controller can tune the second feedback controller to match the system dynamics most closely. This connection may be an electrical connection controlling e.g. a variable resistance or a variable capacitor. In a digital implementation, the connection between the adaptive feedback controller and the second feedback controller can be an instruction modifying the value of a variable corresponding to a constant of the second feedback controller, which is stored in a memory. The same may hold for the first control loop and the first feedback controller.

The control circuit may further comprise a third control loop adapted to assure a constant power level. Maintaining the lamp powered at a desired value minimizes unwanted variations in the brightness of the lamp light output. It may further more be of advantage during the start up phase of the lamp, during which the high intensity discharge lamp heats up.

In a related embodiment, the flowed control loop comprises a power calculation block. The power calculation block provides an instantaneous value for the power consumption of the lamp. This can be achieved by determining for product of lamp current and lamp voltage.

The third control loop may comprise a pulse generator adaptive to produce a pre-shaped current pulse to be added to the constant DC current. The pre-shaped current pulse may be added at the beginning or towards the end of each half cycle of the square wave lamp current, which avoids flickering phenomena by influencing the focal spot on one of the two electrodes inside a high intensity discharge lamp.

In a related embodiment, the pulse generator comprises an inverse filter to compensate for a low pass characteristic in a transfer function for HID lamps regarding input power to light flux. Knowing the low pass characteristic of the transfer function the pulse generator can anticipate the signal by means of the inverse filter. Ideally, the low pass characteristic and the inverse filter cancel out in the transfer function. The advantage is that the pre-shaped current pulse can be chosen rather short, since its target value is rapidly achieved.

In a related embodiment, the inverse filter is a digital filter. This is advantageous if the pulse generator is digital, itself, this allows to consider the digital inverse filter during signal generation, already. According to one embodiment of the present invention, the adaptive feedback controller adjusts the pulse generator. This assures that the pre-shaped current pulse submitted to the lamp results in a output pulse having the desired shape, even when lamp dynamics vary.

Embodiments of a circuit arrangement according to the invention will be made explained making reference to the accompanying drawings. In the drawings,

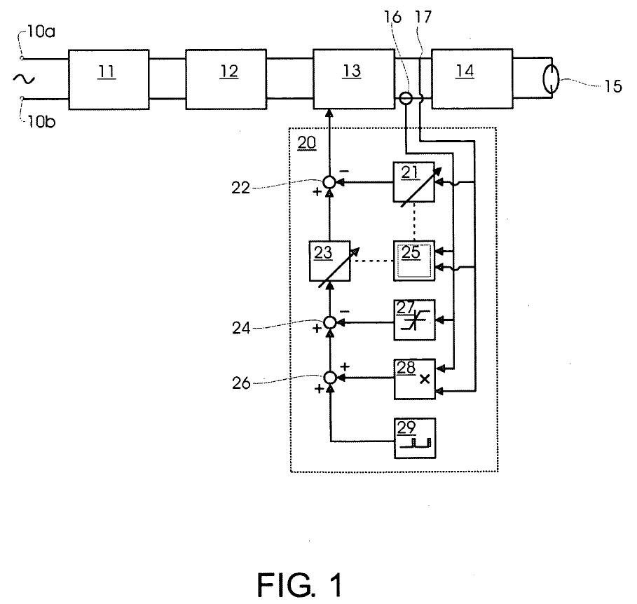

FIG. 1 shows a first embodiment of a circuit arrangement according to the present invention, with a lamp connected to it;

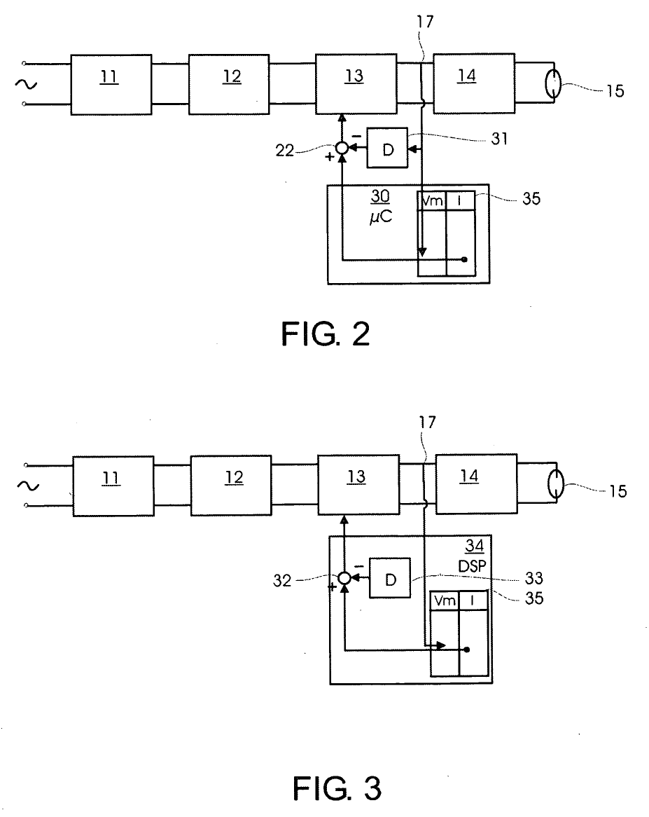

FIG. 2 shows a second embodiment of a circuit arrangement according to the present invention with a lamp connected to it; and

FIG. 3 shows a third embodiment of a circuit arrangement according to the present invention with a lamp connected to it.

In all figures, a lamp driver and a gas discharge lamp 15 are represented as a bloc schema. The lamp driver is a lamp ballast, employing power electronics to condition the current according to the requirements of the lamp. Input terminals 10a and 10b are intended for connecting the lamp driver to a supply voltage source, which can be i.e. an electricity network. Blocs 11, 12, 13, and 14 are power electronics subsystems. More particularly, bloc 11 is an electromagnetic interference (EMI) filter limiting retroaction of the circuit arrangement to the supply voltage source. This EMI filter is connected directly to the supply voltage source at its input terminals and to a power factor correction (PFC) stage 12 at its output side. The PFC stage 12 has the task to keep reactive power that is consumed or produced by the circuit arrangement small. At the same time, it also serves as a rectifier, to convert an AC voltage supplied by the voltage source to a DC voltage. At the DC side of the PFC stage 12, i.e. its output side, it is connected to a DC-to-DC converter 13. Any type of DC-to-DC converter can be used, ranging from a simply and inexpensive buck converter to more complicated full-bridge converters. Since for gas discharge lamp applications a stable and rigid DC voltage is not needed or even desired, a buck converter is preferred for electrical and economic reasons. Nevertheless, the DC-to-DC converter 13 comprises a control input the is used to control the duty cycle, of the DC-to-DC converter 13. Changing the duty cycle of the DC-to-DC converter 13 influences the average current, and correspondingly also the average power, that is transferred from the input side to the output side of the DC-to-DC converter 13. A commutator 14 is fed with the produced direct current. Commutator 14 is usually a full-bridge commutator comprising four power switching elements. Having a constant DC current at its input side, commutator 14 is capable of producing a square-wave current to be supplied to the gas discharge lamp 15. Commutator 15 also comprises an igniter that is used to produce a voltage for igniting the lamp at start-up. Gas discharge lamp 15 can be a high intensity discharge (HID) lamp or an ultrahigh pressure (UHP) lamp. This power electronic configuration is basically the same for the embodiments depicted in FIGS. 1, 2, and 3.

The different embodiments concern control circuits for the generation of the control signal for the DC-to-DC converter 13.

In FIG. 1, a control circuit 20 is represented that is connected to the above described power electronics part of the lamp driver. At a place 17 between the DC-to-DC converter 13 and the commutator, a voltage measurement is taken. At a place 16, a measurement of the current flowing from the DC-to-DC converter 13 to the commutator 14 is made. Within control circuit 20, both, the voltage measurement signal and the current measurement signal are distributed to a number of devices or functional blocs. A first feedback controller 23 and a second feedback controller 21 assume regulating functions. An adaptive feedback controller 25 adjustable acts on internal control parameters of the feedback controllers 21 and 23, such as amplification factors or time constants, in the case of feedback controllers 21 and 23 being P, PI, PID controllers or the like. The adjusting action of adaptive feedback controller 25 on feedback controllers 21 and 23 is indicated by two dashed lines. A limiter 27 limits the current measurement before it is applied to summing point 24. Note that the sign of the current measurement is inversed by the summing point 24. A power calculation block 28 accepts both, the current measurement and the voltage measurement as input and calculates an instantaneous power value in accordance to these measurement values. A pulse generator 29 produces pulses in a periodic manner. These pulses are added to the control signal that is applied to the DC-to-DC converter 13 and are therefore reproduced by the DC-to-DC converter. The pulses appear either at the beginning or towards the end of each half cycle of the commutator 14 so that the current value is increased before commutator 14 inverses the direction of the current that is applied to the lamp 15. Such a current shape has a stabilizing effect on the arc within the lamp 15 and therefore reduces flickering effects of the lamp. Besides the already mentioned summing point 24, control circuit 20 also comprises two further summing points 22 and 26.

Control circuit 20 is capable of handling three feedback control loops. The first control loop controls an average of the DC current provided by the DC-to-DC converter 13. This first control loop comprises current measurement point 16, limiter 27, summing point 24, feedback controller 23, DC-to-DC converter 13, commutator 14 with igniter, and lamp 15. The system-to-be-controlled, or “plant” in control system terminology, is made up by the DC-to-DC converter 13, the igniter in commutator 14, and the lamp 15. Since DC-to-DC controller 13 comprises elements that are capable of storing electric or magnetic energy, it interacts with the output capacitor and igniter in commutator 14 and the lamp 15, which leads to a dynamic system. The resulting dynamic system can be approximated by an oscillatory third-order system. DC-to-DC converter 13 also assumes the role of the actuator in the control loop. The output of the system-to-be-controlled, or plant, is the current that is supplied to the lamp. It should be noted that the measurement of the current is effectuated at the input of the commutator 14. This is admissible, since the absolute value of the current at the input of the commutator 14 is practically the same than the current flowing through the lamp 15. On the other hand, the sign of the current measured at the input of the commutator 14 complies with the actual lamp current only every other half-cycle of the commutator 14. This point of measurement 17 is chosen intentionally, since DC-to-DC converter 13 is capable of controlling the absolute value of the current, only, but not its sign. For this reason, the absolute value of the lamp current is measured at measurement point 17, which omits an additional circuit or calculation bloc for the determination of the absolute value. Limiter 27 works like a saturation in the measurement signal for the lamp current. This leads to a temporary override of the contribution to the eventual control signal produced by this first control loop in order to prioritize contributions to the eventual control signal produced by other control loops. A more detailed description will be given later in this document. Having passed limiter 27, the current measurement signal is passed to summing point 24. The sign of the limited current measurement signal is inversed. The arrow coming from beneath to summing point 24 represents the reference value for the absolute average value of lamp current. The generation of this reference value will be described later on. The result of the summing point 24 represents the control deviation of the first control loop. Feedback controller 23 is provided to minimize this control deviation in accordance with a chosen control strategy. Since the control deviation regarding the absolute average value of the lamp current is expected to have a slow time dependency, feedback controller 23 need not be fast. Furthermore, the control deviation regarding the absolute average value of the lamp current is not expected to be highly oscillatory so that feedback controller 23 need not suppress oscillation, either. On the other hand, any tracking error, i.e. a static difference between reference and system output resulting in a control deviation different from zero, should eventually vanish. The corresponding output of feedback controller 23 passes summing point 22, the function of which will be explained later in this document, to be eventually applied to DC-to-DC converter 13. DC-to-DC converter 13 generates one or several appropriate gating signal(s) for (a) switching element(s) within the converter by using e.g. a pulse width modulation method. The duty cycle of the DC-to-DC converter is adjusted so that at its output a current of the expected magnitude can be collected. It should be noted that, although the commutator part of the plant, the first control loop, which has been explained above, does not experience any commutation of the lamp current. Moreover, this is not necessary for the first control loop, since it is intended to regulate the absolute average value of the lamp current.

The second control loop in FIG. 1 controls small rapid variations of the lamp current around a reference value that are caused by a commutation, additional current pulses, and other disturbances of the lamp current by means of the commutator 14. This second control loop comprises a the voltage measurement point 16, the feedback controller 21, the summing point 22, DC-to-DC converter 13, commutator 14, and lamp 15. As for the first control circuit, the plant is formed by DC-to-DC converter 13, commutator 14, and lamp 15. Contrary to the first control loop, commutation of the lamp current cannot be ignored, anymore, because every commutation excites the dynamic system and leads to oscillations of the lamp current, if no countermeasures are provided. Because these oscillations prevent a stable light output, it is desirable to reduce them to an imperceptible amount This is the task of the second control loop. In this second control loop, feedback controller 21 acts on the voltage measurement signal instead of the control deviation. At summing point 22, the output of feedback controller 21 is subtracted from the reference for the second control loop. The reference for the second control loop equals the control signal of the first control loop. Accordingly, summing point 22 produces a control signal for the DC-to-DC converter that is made up by a contribution of the first control loop and the second control loop.

For both, the first and the second control loop, the plant is represented by the DC-to-DC converter 13, the commutator 14, and the lamp 15. HID and UHP lamps present significant changes of their characteristics due to aging. This prevents an efficient tuning of the first and second control loops, because, if the control parameters are set once and for all during production of the lamp driver, satisfactory results can be expected for a fraction of the lifetime of the lamp, only. For the remainder of the life-time, noticeable deterioration of the stability of the light output occurs. An adaptive feedback controller 25 is provided in control circuit 20. This adaptive feedback controller accepts both the current measurement of measurement point 17, and the voltage measurement at measurement point 16 as input. Adaptive feedback controller 25 is capable of determining the characteristic properties of a dynamic system, such as gain, step response time, oscillation frequency, overshoot, and the like. It is furthermore capable of determining optimal values for a given controller topology, such as P, PI, and PID controllers. These optimized values are transmitted to feedback controllers 21 and 23 via the dashed lines between them and adaptive feedback controller 25. This adjusting action can consist in changing the corresponding control parameters in a memory of the control circuit, if control circuit 20 is e.g. a microprocessor. If at least one of the first and the second control loops is formed by analog elements, adaptive feedback controller 25 may act on variable resistances or capacitances defining the characteristics of at least one of the controllers 21 and 23. This assures lasting performance of the control loops even for high ages of a lamp. It is furthermore possible, to use different lamps with the same lamp driver, since it will quickly adjust itself to the lamp characteristics, as long as these are within a admissible range. This obviates the need for dedicated lamp drivers for particular lamps.

A third control loop maintains a constant power of the light output. The instantaneous power consumption of the lamp is deducted from the measured current and voltage by a power calculation block 28, e.g. by multiplying voltage and current. The power calculation block 28 produces an output that is considered as the principal current reference value for the above explained first control loop. In addition, the current reference value comprises pulses that are added by means of summing point 26 to the output of the power calculation block 28. The pulses are generated by a pulse generator 28 at a rate that is equal to the half-cycle of the commutator 14. In order to compensate for a low pass characteristic in the transfer function regarding input power to light flux, an inverse filter is provided. In the particular embodiment of a digital pulse generator, the filter is preferably also implemented in a digital manner.

FIG. 2 shows a second embodiment of the present invention. First, the second control loop will be described. Again, a voltage measurement is performed at measurement point 17. This corresponding signal is passed to a signal conditioning bloc 31. The signal conditioning bloc 31 reduces the measured voltage by means of a voltage divider, and blocs the DC component of the measurement signal. Accordingly, an AC signal remains at the output of signal conditioning bloc 31. This AC signal corresponds, except for a scaling factor, to the oscillations in the lamp current observed after each commutation of the commutator 14. The output of signal conditioning bloc 31 goes to a summing point 22. In fact, the function of the summing point 22 is the same, as in the first embodiment, which was described with reference to FIG. 1. Again, a measurement signal for the voltage is subtracted from the corresponding reference signal, resulting in a control signal that will be applied to the DC-to-DC converter 13. The plant will react to this control signal with an output signal for the lamp current and the lamp voltage, the latter of which is measured at measurement point 17. This second control loop is preferably implemented by means of analog components.

The first control loop in FIG. 2 starts with a voltage measurement at measurement point 17, as well. However, this signal is passed to a micro-processor or controller 30. A look-up table 35 is stored in the memory of the microprocessor, preferably in the Read Only Memory (ROM). In the left column of the look-up table 35, a plurality of voltage values is stored. In the right column of the look-up table, a plurality of reference current values is stored. Using the look-up table, a reference value for the lamp current can be determined by searching the value in the left column, that most closely corresponds to the measured voltage. The corresponding reference value for the current can be obtained by evaluating the right-column field of the same column. Every pair of measured lamp voltage and reference value for the lamp current leads to the same power consumption value so that on changes in brightness occur when switching to another row of the look-up table. The determined reference value is passed to summing point 22, where it is combined with the output of the signal conditioning bloc 31 to form the control signal for the DC-to-DC converter 13.

FIG. 3 shows a third embodiment of the present invention. It is similar to the embodiment described with respect to FIG. 2, but in this embodiment, a digital signal processor (DSP) 34 is used instead of a microprocessor. The DSP 34 is capable of performing high speed calculations so that even for the second control loop having high bandwidth requirements the corresponding control task is assured. Therefore, not only the controller of the first control loop is implemented as a digital controller, but also the controller of the second control loop. The measured voltage passes through a signal conditioning bloc 33, filtering out the DC component of the measurement signal. In a summing point 32, digitally implemented within the DSP 34, the output of signal conditioning bloc 33 is subtracted from a reference current signal produced by the first control loop. The difference calculated by the summing point 32 is passed as control signal to the DC-to-DC converter 13, which processes it in the above described manner. The first control loop is implemented similarly to the first control loop of the second embodiment described with reference to FIG. 2. The control signal passed to the DC-to-DC converter 13 is a combination of the control signals of the first and second control loops.

1. Circuit arrangement for operating a high intensity discharge lamp, or HID lamp, comprising:
input terminals for connection to a supply voltage source;
a DC-to-DC converter coupled to the input terminals for generating a DC current out of a supply voltage supplied by the supply voltage source;
a control circuit for controlling the DC current at a value that is represented by a reference value Iref;
a commutator for commutating the DC current and comprising lamp connection terminals,
characterized in that said control circuit comprises a first control loop for controlling an average of said DC current to said reference value Iref, and a second control loop for controlling small variations of said DC current around said reference value Iref caused by said commutation of said DC current.

2. Circuit arrangement according to claim 1, wherein said reference value Iref is determined depending on a desired output power value.

3. Circuit arrangement according to claim 2, wherein said reference value Iref is determined depending further on a voltage measured at the input of said commutator.

4. Circuit arrangement according to claim 1, wherein said first control loop comprises a measurement unit for the input voltage to said commutator, a voltage divider, and a DC blocking circuit.

5. Circuit arrangement according to claim 1, wherein said first control loop has a high bandwidth and is adapted to control a dynamic system comprising said high intensity discharge lamp and a lamp ballast.

6. Circuit arrangement according to claim 2, wherein said second control loop comprises means adapted to determine said reference value Iref from a measured voltage signal and said desired output power value.

7. Circuit arrangement according to claim 1, wherein the inverted output of said first control loop is added to the output of said second control loop and the result is applied to said DC-to-DC converter as control signal.

8. Circuit arrangement according to claim 6, wherein said means adapted to determine said reference value Iref is a look-up table adapted to interrelate a measured input voltage for said commutator and a desired output power to said reference value Iref.

9. Circuit arrangement according to claim 6, wherein said means adapted to determine said reference value Iref is a microprocessor configured to execute a program in real time.

10. Circuit arrangement according to claim 4, wherein said first control loop comprises an analog controller and said second control loop comprises a digital microprocessor.

11. Circuit arrangement according to claim 4, wherein said first control loop and said second control loop comprise a digital signal processor, or DSP, digitally performing a high bandwidth control task of said first control loop and a lower bandwidth control task of said second control loop.

12. Circuit arrangement according to claim 1, wherein said control circuit comprises an adaptive feedback controller for adjusting at least one of said first and second control loops according to variations of the controlled system comprising said high intensity discharge lamp and a lamp ballast.

13. Circuit arrangement according to claim 12, wherein said first control loop is a current feedback loop and said second control loop is a voltage feedback loop.

14. Circuit arrangement according to claim 12, wherein said first control loop comprises a shunt before said commutator and a first feedback controller having at least one connection to said adaptive feedback controller.

15. Circuit arrangement according to claim 12, wherein said second control loop comprises means for sensing the output voltage of said DC-to-DC converter and a second feedback controller having at least one connection to said adaptive feedback controller.

16. Circuit arrangement according to claim 12, wherein said control circuit further comprises a third control loop adapted to assure a constant power level.

17. Circuit arrangement according to claim 16, wherein said third control loop comprises a power calculation block.

18. Circuit arrangement according to claim 16, wherein said third control loop comprises a pulse generator adapted to produce a pre-shaped current pulse to be added to said constant DC current.

19. Circuit arrangement according to claim 17, wherein said pulse generator comprises an inverse filter to compensate for a low pass characteristic in a transfer function for HID lamps regarding input power to light flux.

20. Circuit arrangement according to claim 19, wherein said inverse filter is a digital filter.

21. Circuit arrangement according to claim 18, wherein said adaptive feedback controller adjusts said pulse generator.

22. Projection device comprising a high intensity discharge lamp coupled to a circuit arrangement according to claim 1.
